(19) United States
(12) Patent Application Publication
(10) Pub. No.: US 2021/0176926 A1
(43) Pub. Date: Jun. 17, 2021

(54) Method and System in Mechanical Timber Harvesting

(71) Applicant: Ponsse Oyj, Vierma (FI)

(72) Inventors: Panu JOHANSSON, Vierema (FI); Vesa KUMARA, Vierema (FI)

(73) Assignee: Ponsse Oyj, Vierma (FI)

(21) Appl. No.: 17/268,783

(22) PCT Filed: Aug. 30, 2019
(86) PCT No.: PCT/FI2019/050620

§ 371 Date: Feb. 16, 2021

(30) Foreign Application Priority Data
Aug. 30, 2018 (FI) 20185724

(51) Int. Cl. A01G 23/00; G06F 3/14; H04N 7/18

(52) U.S. Cl. CPC A01G 23/00; G06Q 50/02; H04N 7/18; G06F 3/14

(57) ABSTRACT

The invention relates to a method in mechanical timber harvesting. In the method a data system (41) is utilized, in a display device (17) in connection with which previously collected data on a forest machine (10) and/or the surroundings of the forest machine (10) are displayed as a visual element (25). The surroundings of the forest machine (10) are observed using one or more optical devices (28). The observations are recorded time-linked in the data system (41) as a window (42) to be shown in the display device (17) for later utilization. The invention also relates to a system in mechanical timber harvesting.

### CROSS-REFERENCE TO RELATED APPLICATIONS

This application claims benefit of PCT/FI2019/050620 filed Aug. 30, 2019, which claims benefit of Finnish Patent Application No. FI 20185724, filed Aug. 30, 2018, each of which is incorporated by reference in its entirety.

### FIELD OF THE INVENTION

The invention relates to a method in mechanical timber harvesting, in which method a data system is utilized, in a display device in connection with which previously collected data on a forest machine and/or the surroundings of the forest machine are displayed as visual elements. The invention also relates to a system in mechanical timber harvesting.

### BACKGROUND OF THE INVENTION

In a known system, the stand to be felled is planned beforehand and the location of the future logging trail is determined with a rough accuracy on an existing map base, as are the boundaries of the stand. The logging trail is an access track opened in the forest for transporting timber, which is used by both the felling machine and the forwarder or a combination of these. The logging trail winds through the area of the felling stand. The map base and the markings made on it are then transferred to the forest machine's map software. During planning, the number and location of the logging trails are optimized to avoid excessive tree felling, but also to ensure that the felling machine can reach the trees to be felled. In practice, due to landform and local obstacles, such as large stones, the real logging trail is formed only when felling the trees. When the felling machine is working, the locations where a tree was felled and cut into different grades of timber remain in the system's memory. In addition to the locations and grades of timber the amount of timber is also recorded in the system. The recorded data are then available in the forwarder, the driver of which finds the stacks on the basis of the map software. In addition, the driver can plan the number and routes of the drives, for example according to the timber grades, thus minimizing the trips. At the same time, the planning and implementation of local transportation and the monitoring of the situations of roadside stores are nearly real-time.

On the other hand, the system can be used to monitor the productivity and work stages of an individual forest machine. The application gives the driver easily understandable and utilizable information on the forest machine's operation. The system monitors, through the forest machine's control system, for example the forest machine's loading and fuel consumption operation-specifically, for example the operation of the loader when loading and unloading, as well as driving empty or loaded. With the aid of the application, momentary productivity can be compared with the productivity of the whole work shift. Work-stage-specific meters can be used to develop work methods to be more productive and economical and to ensure the operability of control measures. The guiding system gives the driver measured feedback on working to help develop it. On the other hand, the system can be used, for example, to measure the effect of maintenance on the forest machine's productivity.

Despite the system and its diverse functions, it is difficult for a forest-machine driver to analyse his previous work at the end of a work shift, making it difficult to develop operations. The system's analysis is based on numerous individual measurements, which are compared with accepted good values. In practice the driver repeats the same work stages, so that the success or failure of a single work stage is lost in a mass of measurement data. In addition, it is difficult for the driver to remember his own actions, even though the analysis is made immediately after a shift.

### SUMMARY OF THE INVENTION

The invention is intended to create a new type of method for mechanical timber harvesting, with the aid of which timber harvesting is facilitated and improved, as is forest management. In addition, the invention is intended to create a new type of system for mechanical timber harvesting, which is simple and easy to introduce, but which provides more useful feedback than before. The characteristic features of the method according to the present invention are stated in the accompanying claim 1. Correspondingly, the characteristic features of the system according to the invention are stated in the accompanying claim 15. A data system, for example a map program, is utilized in the method according to the invention in a new and surprising way. For example, information, which can be exploited later, can be included in the map software, more specifically in a map view. Timber harvesting is then facilitated and at the same time problem situations can be avoided. In addition, information on felling stands remain in the system, which can be utilized afterwards, for example to show felling results/felling traces, or, for example, to show thinning density or ground damage, and also to examine the actions of the driver and thus to develop operations.

In the following, the invention is described in detail with reference to the accompanying drawings showing some embodiments of the invention, in which

### BRIEF DESCRIPTION OF THE DRAWINGS

FIG. 1 shows a forest machine and the display device in the cab of the forest machine, which shows a map view,

FIG. 2 shows a map view according to the invention,

FIG. 3 shows schematically logging trails and timber stacks formed alongside them,

FIG. 4a shows an enlarged visual element according to the invention,

FIG. 4b shows a second embodiment of an enlarged visual element according to the invention,

FIG. 5 shows a schematic diagram of the system according to the invention,

FIG. 6 shows a variation of the visual element according to the invention.

### DETAILED DESCRIPTION OF THE DRAWINGS

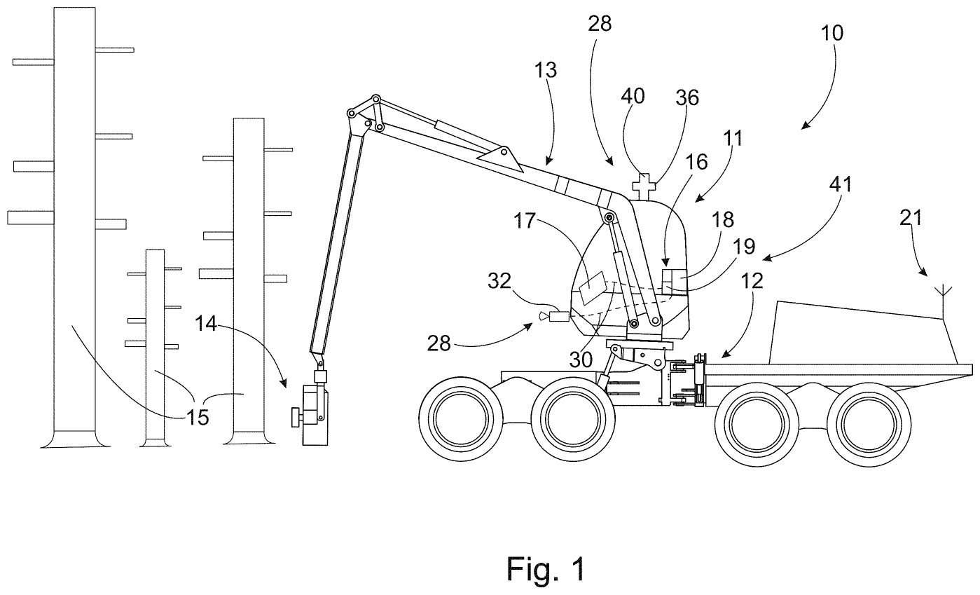

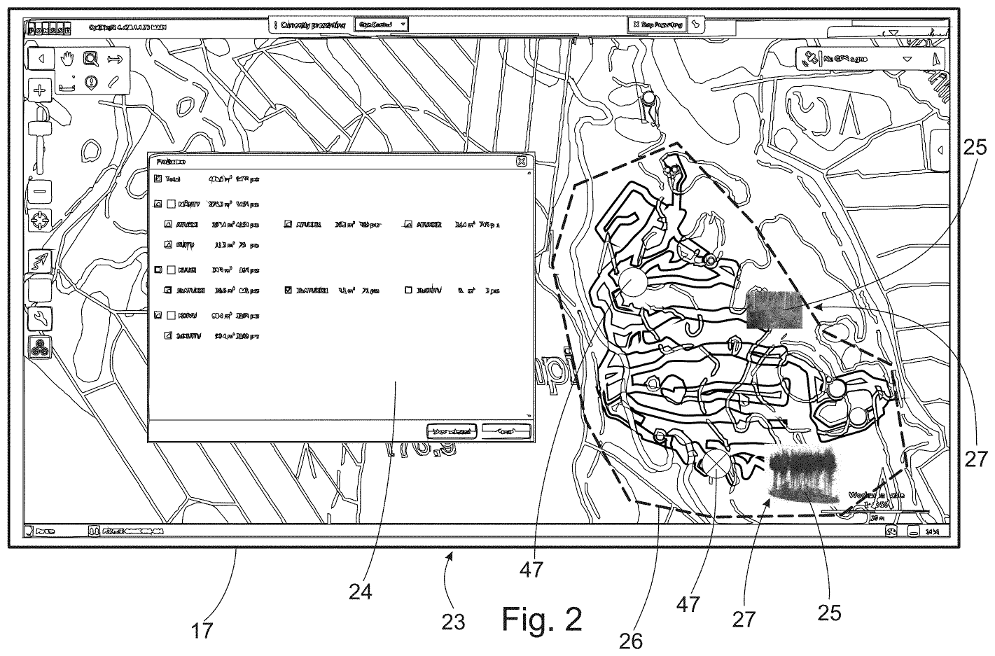

FIG. 1 shows a side view of a forest machine 10. As the matter here is of thinning, the forest machine 10 is a harvester. The harvester fells and cuts trees, which are then collected by a forwarder as a forest machine, utilizing the same logging trails. Generally, the forest machine 10 includes a cab 11, a hoist 13 pivoted to a chassis 12, and a harvester head 14 suspended from the hoist 13 for processing trees 15. The forest machine 10 also includes a data system 41 with data input and processing devices 16 connected to a display device 17 for showing as visual elements 25 information previously collected of the forest machine 10 and/or the surroundings of the forest machine 10. The data input and processing devices 16 include, for example, a computation unit 18, a memory 19, and data-transmission means. The data-transmission means include, for example, cabling 20, and wireless links 21. One task of the display device 17 is to show the logging trail 22 in a map view 23 (FIG. 2). The map view will be described later in greater detail.

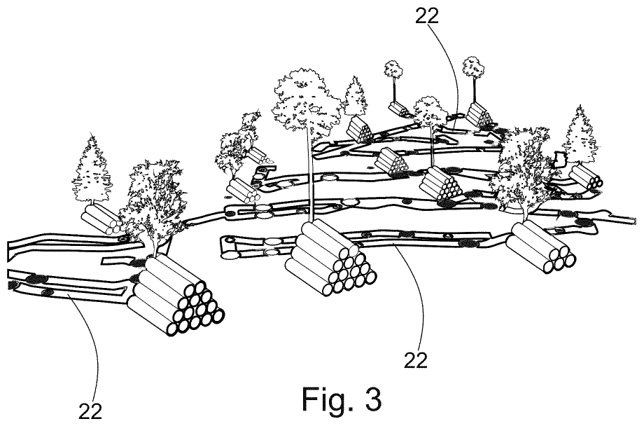

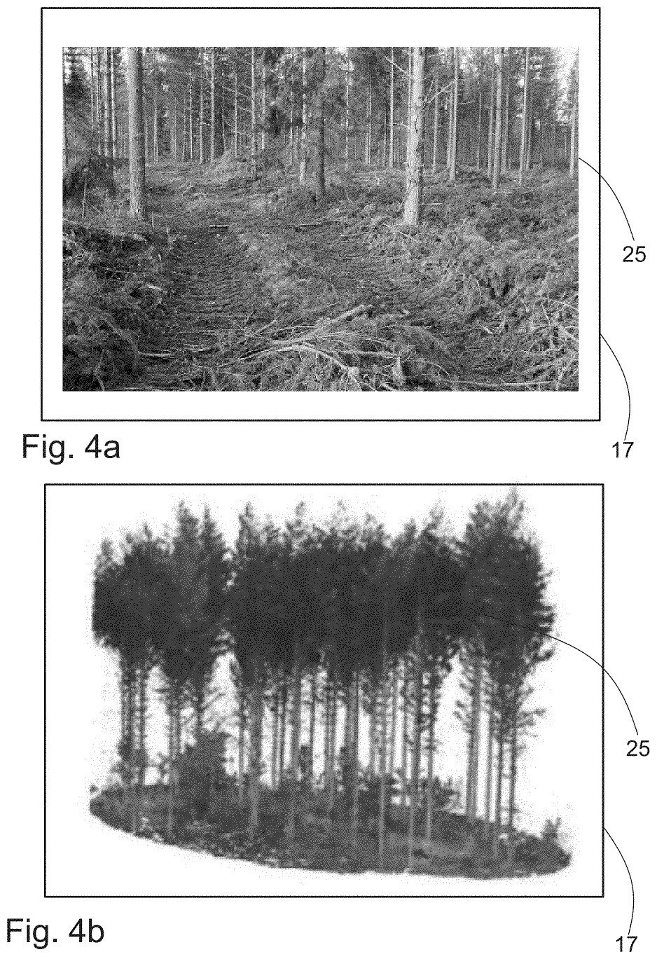

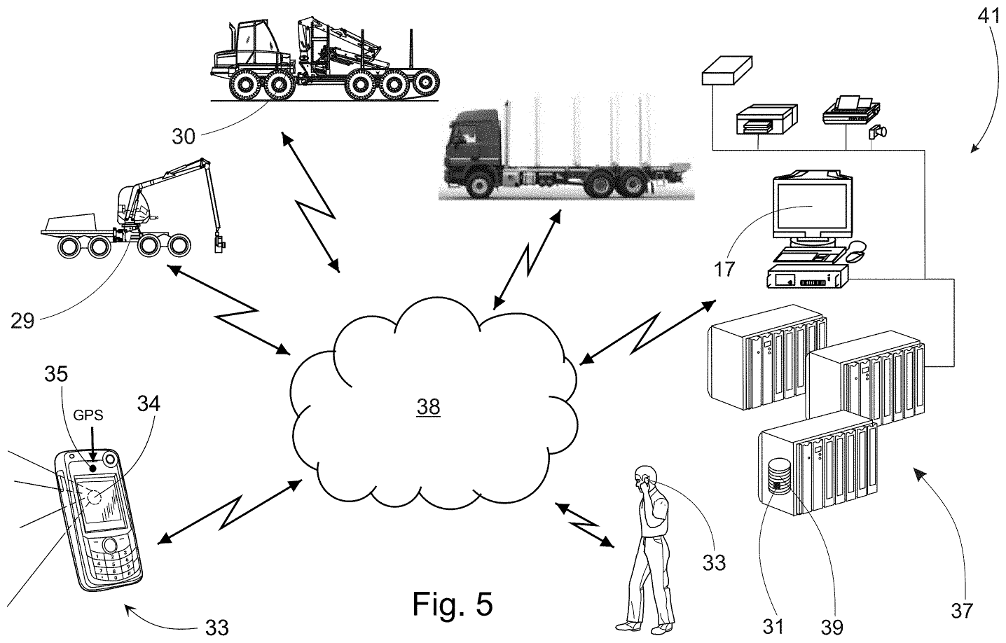

The invention relates to a method in mechanical timber harvesting. In the method, a data system 41 is utilized, in the display device 17 connected to which previously collected information on the forest machine 10 and/or the surroundings of the forest machine 10 are shown as visual elements 25. In general, the surroundings of the said forest machine 10 are observed using one or more optical devices 28. In addition the observations are recorded in a time-linked manner as a view 42 in the data system 41 to be shown in the display device 17 for later utilization. In a first embodiment, a map view 23 is arranged as a view 42, in which the logging trail 22 is defined for the forest machine 10. In addition as a visual element 25, the real properties of the logging trail 22 and/or of a specific location 27 in the felling area are shown. Map software is used to show the map view. The map software is part of the equipment in the forest machine that records the forest machine's operations and guides the driver. For example, the map software guides the driver to the correct felling stand and shows the boundaries of the stand. The same map software and at least position data can be utilized, for example, when transporting the forest machine on a carriage, and also in a timber truck (FIG. 5). The planned logging trails are also shown in the map view. FIG. 2 shows a map view 23 according to the invention. In practice, the logging trail 22 in the map view 23 shown in the map software is defined for the forest machine 10 already before the forest machine arrives 10 at the felling stand. In the situation in FIG. 2, the forest machine has already driven through the stand. In the map view there can also be symbols, for example for the positions and timber grades of the stacks. In this map view 23 is an info-window 24 as a pop-up window, which shows the felled trees in the felling stand as timber grades and species and their numbers. This can also be shown as an illustration according to FIG. 3. With a single glance the driver sees where and how much timber there is. The planning of the logging trails can be done beforehand, for example bases on satellite images and landform maps. According to the invention, a visual element 25 is added to the map view 23, which is used to show the real properties of the logging trail 22 and/or a specific location 27 in the felling area 26, for later utilization. The element shows the situation exactly as it is at that location. At the same time information on the situation remains in the system. In other words, the system further includes one or more optical device 28 for adding a visual element 25 to the map view 23. In addition, the visual element 25 is arranged to include the real properties of the logging trail 22 and/or a specific location 27 in the felling area 26, to be utilized later. FIG. 2 shows two visual elements 25 added to a map view 23. By selecting a visual element 25 from the display device 17, the relevant element is shown enlarged (FIGS. 4a and 4b). Zooming is then also possible.

In the invention a visual element 25 is added to the map view 23 by the forest machine's 10 driver when at each location 27. In other words, the driver can, if necessary, add a visual element at a location that is important in terms of later use or the situation of the felling stand, or some other property. The location can be, for example, a soft point or boulder in the line of the planned logging trail, which must be avoided. On the other hand, the element shows the situation of the trees and ground, which is useful information for both the forest company and the forest owner.

In mechanical timber harvesting, the first work using a forest machine is thinning, in which some of the trees are removed. The visual element 25 is in fact added to the map view 23 for the first time in the forest machine 10 formed by a felling machine 29 and, if necessary, a second time in the forest machine 10 formed by a forwarder 30. Using the felling machine, the situation is then charted before thinning and at the same time the observations by the felling machine's driver are transmitted to the forwarder's driver. Correspondingly, the forwarder's driver can add elements of the situation after thinning. For example, the condition of the trees near the logging trails and the logging trails and their possible depressions can be recorded in the system.

The visual element shows the real situation, an overall impression of which can be seen at a glance. Thus the forest machine's driver can ascertain the situation easily and quickly. On the other hand, the element can be examined more closely to determine the state of an interesting or otherwise important point. Further, the element's information can be analysed by software to determine the properties of the logging trail and its surroundings. In the invention, a record 31, which is a photograph, animation, and/or video, is formed as the visual element 25. All in all, the basic element is an image, which is taken of an object chosen by the driver. The number of records then remains limited and the hardware demands remain reasonable. However, essential data is forwarded and, once formed, the record remains in the system for later use. FIG. 4a shows an image of a logging trail and its surroundings.

The record 31 is preferably formed using a camera 32 belonging to the forest machine 10. The camera can be, for example, an existing reversing camera. On the other hand, a camera that can be oriented more freely can be added to the forest machine. On the other hand, the record 31 can be formed using a mobile device 33, which includes a camera 34 and means 35 for connecting the mobile device 33 to the map software (FIG. 5). Even small details can then be added as a record. On the other hand, wider shots can be taken independently of the forest machine.

An extremely wide and comprehensive shot can be taken by forming the record 31 using a 360-camera 36. The 360-camera can be a mobile device, or it can be installed in the forest machine. For example, a 360-camera 36 arranged on the roof of the cab 11 is at an excellent height for taking a comprehensive record.

A record taken using a 360-camera is comprehensive and the view of the logging trail and its surroundings extends in all directions. In other words, the record contains much information, the software utilization of which is small. Preferably the record 31 is formed as a 3D image, from which distances are determined, on the basis of which the properties of the ground and/or trees are calculated. For example, the number and quality of the trees both before and after thinning can be determined by software. In FIG. 5, the record 31 is already in the server 37, where the information is stored and processed. The server 37 is connected to a cloud service 38, to which the various machines, devices, and users are connected.

The map view 23 together with the visual elements 25 is stored in a database 39, to which access is arranged for third parties. The records can then be exploited for many purposes. For example, the realized thinning efficiency can be determined from a 3D model. FIG. 4b shows a 3D model formed of trees. Correspondingly, depressions in logging trails can be examined afterwards, if for example landowners demand additional investigation of depressions and possible damage to the ground and trees. The system can be further utilized by adding new records with the aid of a mobile device. In other words, if the situation requires a return to the felling stand after thinning, a record is taken at the desired location and added to the system.

The optical device 28 is a camera 32, 34, video camera, 360-camera 36, stereocamera, or 3D-laser scanner 40. Preferably a Lidar scanner is used, where the laser is also used to determine distances. A 3D image is thus formed by combining a camera's image and Lidar's distance data. Using the system described, so sufficient accuracy is achieved that the formation obtained can be used in thinning felling to estimate the thinning density and even to determine the volume and species of the trees. Correspondingly, in final felling the state of the environment, such as the form of the ground, ground damage, and the limits of the felling area can be easily recorded and later ascertained.

In the invention, the logging-road and map software is utilized so that during the drawing of the logging trail, for example, data on the ground-form, trees, storage locations, thinning effect, forest type and undergrowth, straightness of trunks, branch limits, logging trail, and other properties requiring observations along the logging trail such a narrows, rut depths, rut widths a stack co-ordinates can be added to the map view. In practice the data is a record, which is formed visually as an element. The element is illustrative and with suitable means the element can be interpreted by software.

Using the method according to the invention, comprehensive information about an area is recorded. The start-up of the system according to the invention is easy, because related information can be input already while drawing the logging trail. At the same time, the method facilitates working in the area and possibly assists in preventing problem situations, because the driver can see area-specific information beforehand from the map. The situation can also be ascertained afterwards from the recorded information.

In one embodiment of the invention the driver can add additional information at a desired point in the map view. The additional information is preferably a visual element. At its simplest, the visual element is an image, which at a glance shows the situation at the relevant location. For example, the image tells the forwarder driver of a large stone or soft spot, so that the driver can predict the coming situation. Problems such as becoming stuck can then be avoided. At the same time, the location of the element is then certainly correct, compared to a free-form verbal warning.

At its simplest, the record is a digital image, which is taken by a camera in the harvester. Thus the method can be utilized after a software update. In other words, the existing apparatus can be easily utilized.

On the other hand, a mobile device's camera can be used. In modem telephones there is a high-grade camera, positioning feature, and a data link. A high-quality image and its position data can then be immediately transmitted to the harvester's system. On the other hand images can be downloaded to a database, from where they are connected to the map software and displayed in its map view. Besides individual images, image series or videos can be taken.

The operation of a camera demands aiming and taking images takes time. By using a 360-camera the harvester needs to be stationary for only a moment, and an image of a full rotation is recorded. Later the desired direction can be chosen and, if necessary, a detail can be focused on. In practice, the driver only stops at the desired location and starts imaging from the map program. Here it is assumed that the harvester is equipped with a 360-camera. A mobile camera, which is located outside the harvester, can also be used. The driver must then leave the cab for a moment.

The image and other visual elements contain much information, which can be utilized when working. Using advanced technology can further increase the importance of the information. Using a 3D camera or laser sounding real dimensions are also obtained for the element, on the basis of which distances and volumes can be determined. In practice, a dimensionally accurate 3D model forms the information. Then, for example the properties of the trees can be defined with sufficient accuracy. Then for example the thinning intensity and the amount of branches and straightness of the trees can be defined using software. In addition sounding and imaging in general can be done prior to felling trees, when the system records the situation before and after thinning.

An image and its derivatives video, a 360 image, and a 3D model give much more information on the logging trail and its surroundings than the map program's text inputs. For example, ground damage and the felling impression can be recorded in the system. In addition, the state of the felling stand before and after thinning can be shown to the forest owner before and after. Special natural objects can be recorded and correspondingly the effect of mechanical timber harvesting on the undergrowth can be ascertained. On the other hand, for example, also showing rut depressions will assist in resolving possible disputes and promote the restoration of the state of the felling stand.

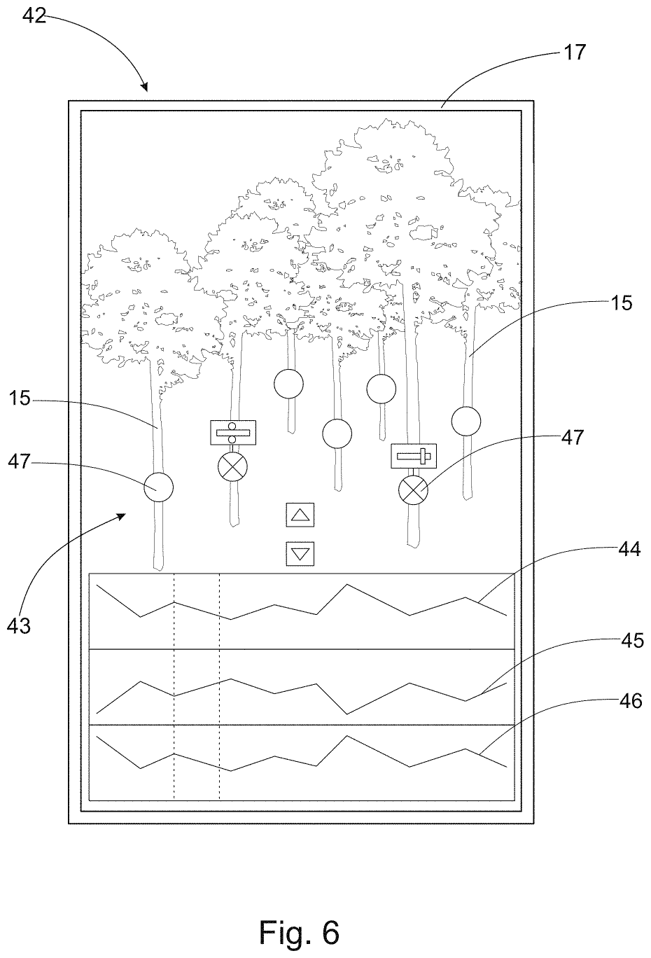

In a second embodiment, a real image 43 of the surroundings of the forest machine 10 is arranged as the view 42, in which measurement data and/or an analysis formed from the measurement data is shown as a visual element 25. The display device 17 of FIG. 6 can be, for example, a display device in the forest machine or some other display device that is connected to the data system. The driver can then analyse their work also after their shift. A driver trainer too can analyse the work of the driver better than previously. In addition to measurement the work of the driver is preferably imaged and an image of the working area and the driver's work is further recorded for later analysis. The data system can be in the forest machine itself or as part of a larger totality.

In FIG. 6, the image 43 is in the upper part of the display device 17. Here analyses of the driver's work have been added as part of the image. The analyses and image are preferably joined together on the basis of time. The attachment can also be made on the basis of place. The image and the data presented will then correspond to the same real situation. From the combined view the driver sees their work in two ways. FIG. 6 shows an example view, in the lower edge of which are several graphs 44, 45, and 46. Each graph shows some measurement data relative to time. The measurement data can be, for example, fuel consumption. Similarly, the analysis can show work productivity. At a quick glance the driver then sees the analysis and particularly deviations in the measurement results are clearly distinguished. A specific point can then be analysed in greater detail and the time data helps to remember the situation. Another way is the image itself, which shows the real situation. The image can be, for example, a composite camera image or a video. In addition, the images are set to form a series, in which images can be browsed back and forth. The image preferably cover at least the working area, but the surroundings can also be images, because deviations in the surroundings can affect the driver's working.

To facilitate analysis, for example the deviations observed by the embodiment can be emphasized in the view. In FIG. 6, this is implemented using icons 47, which are attached to the image 43. A specific icon shows trees which have gone well on the basis of the analysis. Correspondingly, another kind of icon shows trees that could have been harvested more effectively. Here the trees that went well are emphasized by a circle and those that went worse than normal by a circle with a cross in it. In the image and somewhere else in the view there can also be an icon at a point where the settings were changed and other possible traceable matters that affect performance, such as the changing of the saw chain. Here a video is shown when the variable measured in the graph is a function of time. The variables and the video are mutually time linked, so that the real situation is easy to ascertain. Monitoring is further facilitated by a time window 48 emphasized by broken lines. The image can also be wound forwards and backwards, in slow motion or speeded up. Stopping is also possible.

Measurement data and/or an analysis formed from measurement data can also be shown as a visual element in the map view. Then for example, a quick look at the map view after a shift will show where in the stand working went well and where it could perhaps be improved. By selecting the desired visual element, it is then possible to access the data on the point in question in greater detail or the image according to the invention, from which working can be monitored and analysed. Two icons 47 according to the invention are located in the map view 23 of FIG. 2, which show that there is something special or out of the ordinary at the point in question.

The method and system according to the invention make it possible for the driver to go through their work later at their leisure. In addition, the driver can concentrate on the emphasized points, when analysis will take less time than before. The view, image, and other data collected and analysied by the system are recorded in the data system, to which the driver trainer also has access. The driver and driver trainer can then review the material at their own speed. Similarly, the driver and the driver trainer can review working together, even though they are in different places. There can also be a link from the view formed to the map view, when the location of the shift and its surroundings can be examined as part of the analysis.

1. Method in mechanical timber harvesting, in which method a data system (41) is utilized, in a display device (17) in connection with which previously collected data on a forest machine (10) and/or the surroundings of the forest machine (10) are displayed as a visual element (25), characterized in that the surroundings of the forest machine (10) are observed using one or more optical devices (28), and the observations are recorded time-linked in the data system (41) as a view (42) to be shown in the display device (17) for later utilization.

2. Method according to claim 1, characterized in that the view (42) is arranged to be a map view (23), in which a logging trail (22) is defined for the forest machine (10), and the real properties of a specific point (27) in the logging trail (22) and/or the felling area (26) are shown as a visual element (25).

3. Method according to claim 1 or 2, characterized in that a real image (43) of the surroundings of the forest machine (10) is arranged as the view (42), in which measurement data and/or an analysis formed from measurement data is shown as a visual element (25).

4. Method according to claim 2, characterized in that the visual element (25) is added to the map view (23) by the forest machine's (10) driver when at each point (27).

5. Method according to claim 3, characterized in that the image (43) is created automatically.

6. Method according to claim 1 or 2, characterized in that the visual element (25) is added to the map view (23) the first time in a harvester (29) forming the forest machine (10) and if necessary a second time in a forwarder (30) forming the forest machine (10).

7. Method according to any of claims 1-6, characterized in that a record (31), which is a photograph, animation, and/or video, in the map software is formed as the visual element (25).

8. Method according to claim 7, characterized in that the record (31) is created using one or more cameras (32) belonging to the forest machine (10).

9. Method according to claim 7, characterized in that the record (31) is created using a mobile device (33), which includes a camera (34) and means (35) for connecting the mobile device (33) to the data system (41).

10. Method according to any of claims 7-9, characterized in that the record (31) is created using a 360-camera (36).

11. Method according to any of claims 7-10, characterized in that special points and/or deviations are emphasized in the record (31).

12. Method according to any of claims 7-11, characterized in that the record (31) is formed as a 3D image, from which distances are determined, on the basis of which the properties of the ground and/or trees are calculated.

13. Method according to claim 2 or 3, characterized in that the map view (23) or image (43) together with the visual elements (25) are recorded in a database (39), to which access is arranged for third parties.

14. Method according to claim 2, characterized in that measurement data and/or an analysis formed from measurement data are shown as the visual element (25) in the map view (23).

15. System in mechanical timber harvesting, which system includes a forest machine (10), in which is arranged a data system (41) together with data-input and processing devices (16) connected to a display device (17) for showing data collected previously on the forest machine (10) and/or the surroundings of the forest machine (10) as a visual element (25), characterized in that the system further includes one or more optical device (28) arranged to observe the forest machine's (10) surroundings and to record the observations in a time-linked manner in the data system (41) as a view (42) to be shown in the display device (17) for later utilization.

16. System according to claim 15, characterized in that the optical device (28) is a camera (32, 34), video camera, 360-camera (36), stereocamera, or 3D laser scanner (40).
